(19) United States
(12) Patent Application Publication
(10) Pub. No.: US 2025/0369484 A1
(43) Pub. Date: Dec. 4, 2025

(54) MARKING FOR IDENTIFYING ROLLING ELEMENTS IN ROLLING BEARINGS

(71) Applicant: AKTIEBOLAGET SKF, GOTEBORG (SE)

(72) Inventors: Markus KROTTENTHALER, Steyr (AT); Stefan STROBL, Garsten (AT)

(21) Appl. No.: 19/218,731

(22) Filed: May 27, 2025

(30) Foreign Application Priority Data
Jun. 3, 2024 (DE) 102024205105.5

(51) Int. Cl. F16C 41/00

(52) U.S. Cl. CPC F16C 41/008

(57) ABSTRACT

A rolling element for a rolling bearing has a body with an outer running surface. The running surface is provided with at least one marking designed to identify the rolling element. The marking may include at least one notch in the running surface of the rolling element body or a plurality of notches in the running surface. The plurality of notches of the marking may all be located within an area of the running surface having a predetermined size. Further, the notch or each one of the plurality of notches may be filled with a filler material, the filler material being different than a material of the rolling element.

### CROSS-REFERENCE

This application claims priority to German patent application no. 102024205105.5 filed on Jun. 3, 2024, the contents of which are fully incorporated herein by reference.

### BACKGROUND OF THE INVENTION

The present invention relates to a rolling bearings, and more particularly to rolling elements for a rolling bearing.

Depending on the type and/or the material of a rolling element and/or an application for which this rolling element is employed, the service life of the rolling bearing in which the rolling element is employed can be less than a service life of the rolling element. These rolling elements might be capable of being reused, for example when the rolling bearings are being reconditioned.

However, in order to be able to estimate when, in the case of a rolling bearing that comprises reused rolling elements, a bearing failure might occur and/or how long the service life of the reused rolling element might be, it is important to have as much information as possible about an individual rolling element.

### SUMMARY OF THE INVENTION

An object of the present invention is therefore to provide a rolling element which can be identified even after use in a rolling bearing.

Disclosed herein is a rolling element for a rolling bearing, wherein a running surface of the rolling element is provided with at least one marking designed to identify the rolling element.

The marking may be designed or configured in particular to uniquely identify the rolling element. In particular, the marking may be a numerical marking, an alphabetic marking, a symbolic marking, a colour marking, a one-dimensional code, a two-dimensional code, or another suitable marking. These types of marking allow the rolling element provided therewith to be identified.

The marking can also be a combination of two or more different types of markings. For example, the marking can comprise a combination of at least two of the following types of marking: a numerical marking, an alphabetic marking, a symbolic marking, a color marking, a one-dimensional code, a two-dimensional code, etc. The marking allows the rolling element provided therewith to be readily identified.

In particular, the at least one marking is configured to be read out optically, electronically, magnetically, by interferometry, and/or by spectroscopy.

Since the marking is provided on a running surface of the body of the rolling element, the rolling element can be any type of rolling element. The rolling element may be a roller, a cylindrical roller, a conical roller, a needle roller, a barrel-like roller, a sphere, or any other known type of rolling element.

Providing the marking enables identification of a specific rolling element. For example, the marking may be a unique marking associated with exactly one single particular rolling element.

Preferably, the at least one marking may be designed or configured to identify a rolling bearing, a set of rolling elements, and/or an individual rolling element. Such identification makes it easier to estimate the loadings to which an already employed rolling element has been subjected.

Furthermore, an association between the marking and at least one property of the rolling element can be stored in a database. The property can include, for example, a specific material of the rolling element, a material class, a material quality, a production date, the type and/or duration of the first application in which the rolling element was employed, or similar properties and/or information. Such properties can make it easier to estimate the risks that may arise when this rolling element is reused.

Advantageously, the marking can also be used to reduce a risk of being counterfeited. This makes it possible to ascertain whether the rolling element is an original product or a counterfeit. It is also possible to more easily estimate the risks that arise when this rolling element is used. If, for example, the rolling element has been employed in an application that is known to subject the rolling element to high loading, the risk that the rolling element may fail may be greater than with an application that subjects the rolling element to lower or lesser loading. It can also be possible for a database to store whether, and for what reason, a rolling bearing has failed. The reason for a failure can also give clues or information that make it possible to estimate the risk of failure when the previously used rolling element is reused.

In particular, the marking may be a marking which does not interfere with the usability of the rolling element in the rolling bearing. In particular, the marking can be selected such that it does not disrupt a lubricating film formed by a lubricant in a rolling bearing in which the rolling element provided with the marking is employed. That is to say, the lubricating film that forms in a rolling bearing is not impaired by the presence of the marking. This makes it possible to ensure proper operation of the rolling element and the rolling bearing in which the rolling element is employed. For example, the marking can be a color, a coating, an ion implanted in the base material of the rolling element, a recess, an elevation, or the like.

The marking preferably comprises at least one notch in the running surface of the rolling element. The notch may be for example a notch created in the base material of the rolling element using a laser. The notch may also be created using a mechanical tool (e.g., an end mill). Providing a notch has the advantage that the marking can be read out easily, quickly and conveniently. A notch also has the advantage that it is robust and cannot be easily removed. A notch also makes it possible to reduce the risk of the marking dissolving as a result of interaction with a lubricant.

The dimensions and/or the shape of the notch may be selected in particular such that they do not adversely affect a performance of the rolling element and/or of the rolling bearing in which the rolling element is employed. In particular, the dimensions and/or the shape of the notch can be selected such that it does not disrupt a lubricating film formed by a lubricant in a rolling bearing in which the rolling element provided with the marking is employed. That is to say, the lubricating film that forms in a rolling bearing is not impaired by the presence of the at least one notch. Since the respective requirements for rolling bearings and rolling elements greatly depend on the specific application, the dimensions and/or the shape of the notch can also be selected on the basis of the intended application and/or the lubricant employed. This makes it possible to be able to employ the rolling element, in spite of the at least one notch, in a rolling bearing without excessively reducing a service life of the rolling element and/or rolling bearing.

Furthermore, the marking may be of an order of magnitude which corresponds to an acceptable surface defect for the application. In particular, a diameter and/or a depth of the marking can be selected so as to correspond to the diameter and/or to the depth of a surface defect of the rolling element that is in a range still acceptable for the intended application of the rolling element or below this range. For example, the notch may have a diameter in a range of between 0.5 μm and 10 μm. In addition, the notch may have a depth in a range of between 0.5 um and 10 μm.

In addition, the at least one marking may comprise multiple notches or a plurality of notches. For example, the multiple notches may form a two-dimensional code. The two-dimensional code may be, for example, a data matrix code (DMC), a QR code, a dot code, or another suitable two-dimensional code. The multiple notches may also form a barcode or another code suitable for storing the required information on the rolling element. Providing a marking with multiple notches has the advantage that more information can be stored in or provided by the marking. In addition, the multiple notches make it possible to provide a more robust marking, which can also be read out after the rolling element has been employed in a rolling bearing.

Preferably, the multiple notches of the marking may be located within an area which has a specific or predetermined size. For example, this makes it possible to ensure that, when multiple rolling elements are provided with a marking, these markings are located at the same position on each rolling element. This can make it easier and/or faster to read out the marking.

In addition, in particular if the marking is multiple notches, it can be ensured that a notch density is in a specific range. The term “notch density” as used in the present application is intended to mean the number of notches per predefined area. For example, the occurrence of rolling-element damage and/or damage to the rolling bearing may be more likely with a greater density of surface irregularities on the rolling element. In other words, the risk of damage occurring increases the more densely the notches are grouped together. Distributing the multiple notches over a specific area makes it possible to ensure that a notch density on the surface is below a specific density.

The specific density can in turn depend on various parameters, such as the type of application, the lubricant employed, the particular material of the rolling element, and/or the raceways on which the rolling element rolls. For example, the specific area may lie in a range between 0.1 mm² and 10 mm², preferably between 0.5 mm² and 5 mm².

In addition, the notches may be filled with a filler material which differs from a material of the rolling element. By filling the notches, it is possible, for example, to mitigate an effect of the notch on the surface quality of the rolling element and/or an effect of the notch on the surface of the bearing ring and/or improve a performance of the rolling element.

In particular, the filler material may be a solid lubricant and/or a contrast agent and/or a fluorescent material. For example, the solid lubricant used to fill the notch(es) may be molybdenum disulfide (MoS₂), graphite, polytetrafluoroethylene (PTFE). Employing a solid lubricant as filler material can in particular have the advantage that a lubricating film in the rolling bearing can be made more stable, with the result that the risk of failure of the rolling bearing owing to the marking can be further reduced.

The contrast agent can in particular be a material which is readily distinguished due to a good contrast of the contrast agent with the base material of the rolling element for the selected reading-out process. The fluorescent material employed may be, for example, a material which has a different fluorescence from the base material. For example, this can make it possible for the marking to be easier and/or faster to read out. As an alternative, this can also make it possible for the marking to not be identifiable by third parties.

With preference, the rolling element may be made of a ceramic material. Ceramic rolling elements can be, on the one hand, very expensive and/or energy-intensive to produce but, on the other hand, can have a long service life. In addition, ceramic rolling elements can have a high hardness, so they can generally be reused. For these reasons, it is desirable to provide as much information as possible about the rolling element and/or the first application for which it was employed in order to be able to better estimate the risk of premature failure.

Further advantages and advantageous embodiments are specified in the description, the drawings and the claims. In particular the combinations of the features specified in the description and in the drawings are purely illustrative here, and therefore the features can also be present individually or in other combinations

### BRIEF DESCRIPTION OF THE SEVERAL VIEWS OF THE DRAWINGS

The invention will be described in detail hereinafter with reference to working examples shown in the drawings. The working examples and the combinations shown in the working examples are purely illustrative and are not intended to restrict the scope of protection of the invention. The latter is defined solely by the appended claims.

In the figures:

FIG. 1 shows a rolling element for a rolling bearing according to a first embodiment, and

FIG. 2 shows a rolling element for a rolling bearing according to a second embodiment.

### DETAILED DESCRIPTION OF THE INVENTION

Identical or functionally identical components are identified by the same reference signs hereinafter.

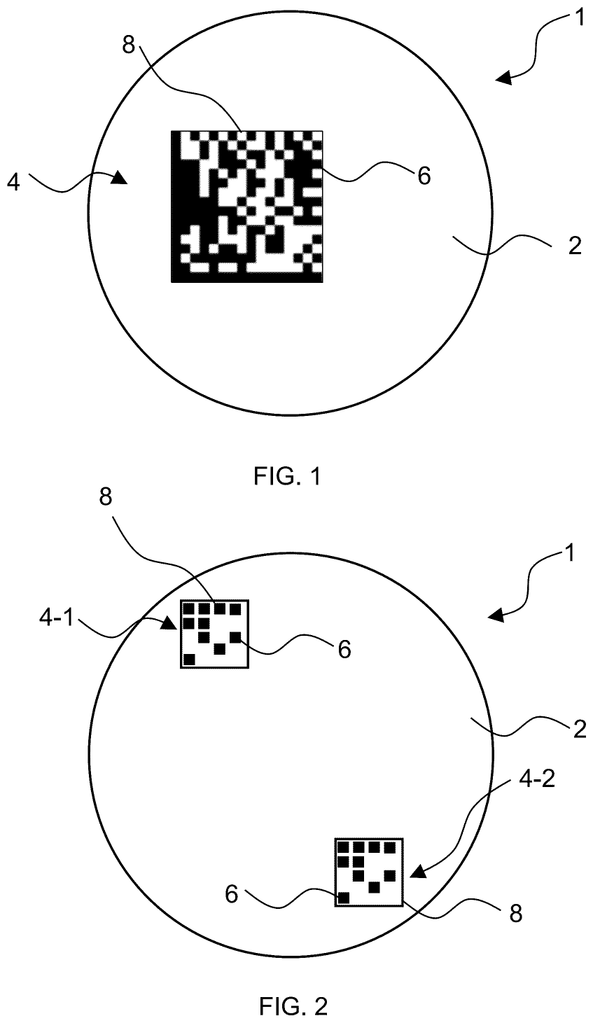

FIG. 1 shows a rolling element 1 for a rolling bearing including a body with an outer running surface 2. The rolling element 1 shown in FIG. 1 may in particular be a sphere. As an alternative, the rolling element 1 may also be another type of rolling element, such as a roller, a cylindrical roller, a conical roller, a needle roller, a barrel-like roller. In addition, the rolling element 1 may be made of a ceramic material.

In order to identify a rolling bearing in which the rolling element 1 has been employed, a set of rolling elements in which the rolling element 1 was employed, and/or the individual rolling element 1, the running surface 2 of the rolling element 1 is provided with at least one marking 4 designed to identify the rolling element 1.

As FIG. 1 shows, the marking 4 is a two-dimensional code, such as a data matrix code (DMC). It is, however, also conceivable to employ another type of marking 4. For example, the marking 4 can also be a numerical marking, an alphabetic marking, a symbolic marking, a colour marking, a one-dimensional code, or a combination of the aforementioned markings. In particular, the marking 1 can be able to be read out optically, electronically, magnetically, by interferometry, and/or by spectroscopy.

In FIG. 1, the marking 4 is formed by multiple notches 6, i.e., a plurality of notches 6, which together form the two-dimensional code. The notches 6 may be introduced into the surface 2 of the rolling element 1, for example mechanically (i.e., machining) and/or by using a laser.

In order to prevent the notch 6 from interfering with the usability of the rolling element 1 in the rolling bearing, the dimension and/or depth of the notch 6 is selected such that they/it do(es) not disrupt a lubricating film formed by a lubricant in a rolling bearing. For example, the notch 6 may have a diameter in a range of between 0.5 μm and 10 μm. In addition, the notch may have a depth in a range of between 0.5 μm and 10 μm.

With preference, the marking 4 is located in a specific area 8 which has a specific or predetermined size. The size of the specific area 8 may lie in a range between 0.1 mm² and 10 mm², preferably between 0.5 mm² and 5 mm².

In addition, the notches 6 may be filled with a filler material which is formed of a material different than a material of the rolling element 1. By filling the notches 6, it is possible for example to mitigate an effect of the notch 6 on the surface quality of the rolling element 1 and/or an effect of the notch 6 on the surface of the bearing ring and/or improve a performance of the rolling element 1.

In particular, the filler material may be a solid lubricant and/or a contrast agent and/or a fluorescent material. For example, the solid lubricant used to fill the notches 6 may be molybdenum disulfide (MoS₂), graphite, polytetrafluoroethylene (PTFE), etc. Employing a solid lubricant as filler material can in particular have the advantage that a lubricating film in the rolling bearing can be made more stable, with the result that the risk of failure of the rolling bearing caused by the marking 4 can be further reduced.

The contrast agent can in particular be a material which is readily distinguishable from the base material so as to provide a good contrast with the base material of the rolling element 1 during the selected reading-out process. A fluorescent material may be employed, for example, a material which has a different fluorescence from the base material of the rolling element 1. For example, such fluorescence difference may enable easier and/or faster reading out of the marking 4. As an alternative, the marking 4 may be formed so as to be unidentifiable by third parties.

FIG. 2 shows a rolling element 1 according to a second working example. The rolling element 1 in FIG. 2 differs from the rolling element 1 in FIG. 1 in that the rolling element 1 of FIG. 2 is provided with two markings 4-1 and 4-2. Each of the markings 4-1 and 4-2 may be suitable by itself to identify the rolling element 1, or the markings 4-1 and 4-2 may be designed to identify the rolling element 1 together in combination. It is also conceivable that the first marking 4-1 is associated with a first portion of information about the rolling element 1 and the second marking 4-2 is associated with a second portion of information about the rolling element 1.

In summary, providing at least one marking on the running surface of a rolling element makes it possible to obtain information about the rolling element and/or the first application for which it was employed, this information making it possible to be able to estimate the risk of premature failure as closely as possible. This makes it possible to reuse rolling elements and thus reduce costs. Furthermore, an association between the marking and at least one property of the rolling element can be stored in a database. The property can include, for example, a material of the rolling element, a material class, a material quality, a production date, the type of the first application for which the rolling element was employed, or the like. This can make it easier to estimate the risks that can arise when this rolling element is reused.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

### LIST OF REFERENCE SIGNS

1 Rolling element
2 Running surface
4, 4-1, 4-2 Marking
6 Notch
8 Area

We claim:

1. A rolling element for a rolling bearing, the rolling element comprising:
a body having a running surface, the running surface being provided with at least one marking configured to identify the rolling element.

2. The rolling element according to claim 1, wherein the marking includes at least one notch in the running surface of the rolling element body.

3. The rolling element according to claim 1, wherein the at least one marking includes a plurality of notches in the running surface of the rolling element body.

4. The rolling element according to claim 3, wherein the plurality of notches of the marking are all located within an area of the running surface having a predetermined size.

5. The rolling element according to claim 4, wherein each one of the plurality of notches is filled with a filler material, the filler material being different than a material of the rolling element.

6. The rolling element according to claim 5, wherein the filler material includes at least one of a solid lubricant, a contrast agent and a fluorescent material.

7. The rolling element according to claim 1, wherein the at least one marking is a two-dimensional code.

8. The rolling element according to claim 1, wherein the at least one marking is readable optically, electronically, magnetically, by interferometry, and/or by spectroscopy.

9. The rolling element according to claim 1, wherein the rolling element is formed of a ceramic material.

10. The rolling element according to claim 1, wherein the rolling element is a sphere.

11. The rolling element according to claim 1, wherein the at least one marking is configured to identify a rolling bearing, a set of rolling elements, and/or an individual rolling element.
